(19) United States
(12) Patent Application Publication
(10) Pub. No.: US 2026/0187281 A1
(43) Pub. Date: Jul. 2, 2026

(54) DATA SET ANONYMIZATION THROUGH SELECTIVE MASKING OF STATISTICAL PERSONALLY IDENTIFIABLE INFORMATION

(71) Applicant: Dell Products L.P., Round Rock, TX (US)

(72) Inventors: Parminder Singh Sethi, Ludhiana (IN); Avinash Kumar, Patna (IN); Praveen Kumar, Noida (IN)

(21) Appl. No.: 19/003,516

(22) Filed: Dec. 27, 2024

(51) Int. Cl. G06F 21/62

(52) U.S. Cl. CPC G06F 21/6254

(57) ABSTRACT

An apparatus comprises at least one processing device configured to identify statistical personally identifiable information (PII) variables in a dataset and to determine, for each of the statistical PII variables, a sensitivity level characterizing a contribution of that statistical PII variable in revealing individual user identities in the dataset. The at least one processing device is further configured to select, for each of the statistical PII variables, a masking level to be applied to that statistical PII variable based at least in part on the determined sensitivity level for that statistical PII variable. The at least one processing device is further configured to anonymize the dataset by applying selective masking to respective ones of the statistical PII variables in accordance with selected masking levels. The at least one processing device is further configured to perform one or more analytics operations in an information technology infrastructure utilizing the anonymized dataset.

### BACKGROUND

Artificial intelligence (AI) and machine learning (ML) workloads may utilize and generate vast amounts of data that needs to be protected. Data protection for AI/ML workloads should take into account the types of data being analyzed, the AI/ML models that are utilized, and regulatory and privacy requirements for the data, including adherence to compliance requirements for long-term retention of sensitive data. Sensitive data includes Personally Identifiable Information (PII) associated with one or more users. Users may share PII with enterprises, organizations or other entities for various purposes.

### SUMMARY

Illustrative embodiments of the present disclosure provide techniques for data set anonymization through selective masking of statistical personally identifiable information.

In one embodiment, an apparatus comprises at least one processing device comprising a processor coupled to a memory. The at least one processing device is configured to identify a set of statistical personally identifiable information variables in at least one dataset that is to be utilized in one or more analytic operations in an information technology infrastructure. The at least one processing device is also configured to determine, for each of the statistical personally identifiable information variables in the identified set of statistical personally identifiable information variables, a sensitivity level characterizing a contribution of that statistical personally identifiable information variable in revealing one or more individual user identities in the at least one dataset. The at least one processing device is further configured to select, for each of the statistical personally identifiable information variables in the identified set of statistical personally identifiable information variables, a masking level to be applied to that statistical personally identifiable information variable based at least in part on the determined sensitivity level for that statistical personally identifiable information variable. The at least one processing device is further configured to anonymize the at least one dataset, wherein anonymizing the at least one dataset comprises applying selective masking to respective ones of the statistical personally identifiable information variables in the identified set of statistical personally identifiable information variables in accordance with selected masking levels. The at least one processing device is further configured to perform the one or more analytics operations in the information technology infrastructure utilizing the anonymized at least one dataset.

These and other illustrative embodiments include, without limitation, methods, apparatus, networks, systems and processor-readable storage media.

### BRIEF DESCRIPTION OF THE DRAWINGS

FIG. 1 is a block diagram of an information processing system configured for data set anonymization through selective masking of statistical personally identifiable information in an illustrative embodiment.

FIG. 2 is a flow diagram of an exemplary process for data set anonymization through selective masking of statistical personally identifiable information in an illustrative embodiment.

FIG. 3 shows a system flow for identifying statistical personally identifiable information in a site reliability engineering infrastructure in an illustrative embodiment.

FIG. 4 shows a system configured for performing anonymization of statistical personally identifiable information in an illustrative embodiment.

FIG. 5 shows a process flow for selective masking of statistical personally identifiable information in an illustrative embodiment.

FIG. 6 shows a table of sensitivity scores, masking levels and masking techniques for a set of attributes of a dataset in an illustrative embodiment.

FIGS. 7 and 8 show examples of processing platforms that may be utilized to implement at least a portion of an information processing system in illustrative embodiments.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources.

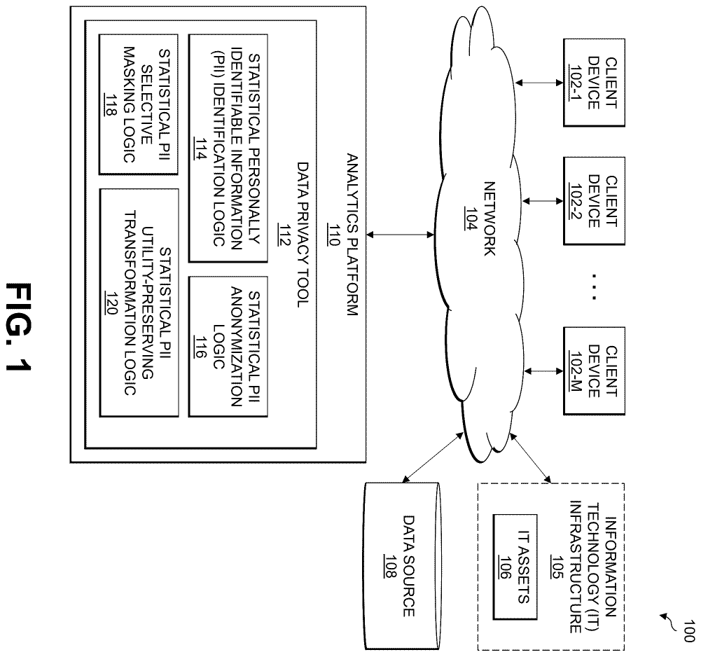

FIG. 1 shows an information processing system 100 configured in accordance with an illustrative embodiment. The information processing system 100 is assumed to be built on at least one processing platform and provides functionality for data set anonymization through selective masking of statistical personally identifiable information (PII). The information processing system 100 includes a set of client devices 102-1, 102-2, . . . 102-M (collectively, client devices 102) which are coupled to a network 104. Also coupled to the network 104 is an IT infrastructure 105 comprising one or more IT assets 106, a data source 108, and an analytics platform 110. The IT assets 106 may comprise physical and/or virtual computing resources in the IT infrastructure 105. Physical computing resources may include physical hardware such as servers, storage systems, networking equipment, Internet of Things (IoT) devices, other types of processing and computing devices including desktops, laptops, tablets, smartphones, etc. Virtual computing resources may include virtual machines (VMs), containers, etc.

In some embodiments, the analytics platform 110 is used for an enterprise system. For example, an enterprise may subscribe to or otherwise utilize the analytics platform 110 for performing analytics on one or more data sets (e.g., obtained from data source 108, which may be implemented as a database or other data store) for an enterprise, organization or other entity. In some cases, the data sets are generated by the IT assets 106 of the IT infrastructure 105, or by the client devices 102 interacting with one or more applications and services hosted by the IT assets of the IT infrastructure 105. The analytics may include performing data analysis utilizing artificial intelligence (AI) and/or machine learning (ML). In some cases, PII may be anonymized and utilized in AI/ML workloads. Such use, however, presents a risk of re-identification, where anonymized PII is matched with one or more specific users, which can result in privacy breaches, loss of trust, and reputational damage. As will be described in further detail below, the analytics platform 110 implements a data privacy tool 112 for ensuring that that data analytics processing does not reveal PII in the data sets, including “traditional” and “statistical” PII. Traditional PII includes information such as names, addresses, etc. which can directly or uniquely identify an individual on its own. Statistical PII, in contrast, refers to data that, while not explicitly or uniquely identifying an individual on its own, can be used in combination with other information to identify a likely person or individual. As used herein, the term “enterprise system” is intended to be construed broadly to include any group of systems or other computing devices. For example, the IT assets 106 of the IT infrastructure 105 may provide a portion of one or more enterprise systems. A given enterprise system may also or alternatively include one or more of the client devices 102. In some embodiments, an enterprise system includes one or more data centers, cloud infrastructure comprising one or more clouds, etc. A given enterprise system, such as cloud infrastructure, may host assets that are associated with multiple enterprises (e.g., two or more different businesses, organizations or other entities).

The client devices 102 may comprise, for example, physical computing devices such as IoT devices, mobile telephones, laptop computers, tablet computers, desktop computers or other types of devices utilized by members of an enterprise, in any combination. Such devices are examples of what are more generally referred to herein as “processing devices.” Some of these processing devices are also generally referred to herein as “computers.” The client devices 102 may also or alternately comprise virtualized computing resources, such as VMs, containers, etc.

The client devices 102 in some embodiments comprise respective computers associated with a particular company, organization or other enterprise. Thus, the client devices 102 may be considered examples of assets of an enterprise system. In addition, at least portions of the information processing system 100 may also be referred to herein as collectively comprising one or more “enterprises.” Numerous other operating scenarios involving a wide variety of different types and arrangements of processing nodes are possible, as will be appreciated by those skilled in the art.

The network 104 is assumed to comprise a global computer network such as the Internet, although other types of networks can be part of the network 104, including a wide area network (WAN), a local area network (LAN), a satellite network, a telephone or cable network, a cellular network, a wireless network such as a WiFi or WiMAX network, or various portions or combinations of these and other types of networks.

The data source 108, as discussed above, may be a source of one or more datasets that are to be analyzed utilizing the analytics platform 110. The datasets may include PII, including traditional PII and/or statistical PII. The data source 108 may also store information that is utilized by the analytics platform 110 for performing data analytics operations, such as AI/ML models, training data, etc. The data source 108 may be implemented utilizing one or more storage systems. The term “storage system” as used herein is intended to be broadly construed. A given storage system, as the term is broadly used herein, can comprise, for example, content addressable storage, flash-based storage, network-attached storage (NAS), storage area networks (SANs), direct-attached storage (DAS) and distributed DAS, as well as combinations of these and other storage types, including software-defined storage. Other particular types of storage products that can be used in implementing storage systems in illustrative embodiments include all-flash and hybrid flash storage arrays, software-defined storage products, cloud storage products, object-based storage products, and scale-out NAS clusters. Combinations of multiple ones of these and other storage products can also be used in implementing a given storage system in an illustrative embodiment.

Although not explicitly shown in FIG. 1, one or more input-output devices such as keyboards, displays or other types of input-output devices may be used to support one or more user interfaces to the analytics platform 110, as well as to support communication between the analytics platform 110 and other related systems and devices not explicitly shown.

The analytics platform 110 may be provided as a cloud service that is accessible by one or more of the client devices 102 to allow users thereof to perform data analytics operations. In some embodiments, the client devices 102 are assumed to be associated with users of an enterprise, organization or other entity that seeks to perform data analytics. In some embodiments, the client devices 102 are utilized by members of the same enterprise, organization or other entity that operates the analytics platform 110. In other embodiments, the client devices 102 are utilized by members of one or more enterprises, organizations or other entities different than the enterprise, organization or other entity that operates the analytics platform 110 (e.g., a first enterprise provides analytics functionality for multiple different customers, businesses, etc.). Various other examples are possible.

In some embodiments, the client devices 102 and/or the IT assets 106 of the IT infrastructure 105 may implement host agents that are configured for automated transmission of information with the data source 108 and the analytics platform 110 regarding analytics operations. It should be noted that a “host agent” as this term is generally used herein may comprise an automated entity, such as a software entity running on a processing device. Accordingly, a host agent need not be a human entity.

The analytics platform 110 in the FIG. 1 embodiment is assumed to be implemented using at least one processing device. Each such processing device generally comprises at least one processor and an associated memory, and implements one or more functional modules or logic for controlling certain features of the analytics platform 110. In the FIG. 1 embodiment, the analytics platform 110 implements a data privacy tool 112. The data privacy tool 112 comprises statistical PII identification logic 114, statistical PII anonymization logic 116, statistical PII selective masking logic 118, and statistical PII utility-preserving transformation logic 120. The statistical PII identification logic 114 is configured to identify, within one or more datasets that are being analyzed by the analytics platform 110, statistical PII variables. The statistical PII anonymization logic 116 is configured to implement anonymization to protect the identified statistical PII variables in the datasets that are being analyzed by the analytics platform 110. This may include, for example, generalization (e.g., replacing specific values with broader categories), addition of random noise to obscure individual values while preserving aggregate statistics (e.g., by injecting random values within defined parameters, swapping values across records, etc.). The statistical PII selective masking logic 118 is configured to implement masking to substitute sensitive information in the identified statistical PII variables with pseudonyms or tokens (e.g., replacing names with randomly-generated identifiers). The PII selective masking logic 118 may identify the sensitivity of different attributes (e.g., the identified statistical PII variables), and apply masking techniques accordingly (e.g., applying no or minimal masking for ones of the identified statistical PII variables deemed less sensitive, performing more rigorous masking for ones of the identified statistical PII variables deemed highly sensitive). The statistical PII utility-preserving transformation logic 120 is configured to preserve data utility in the datasets that are being analyzed by the analytics platform 110 while protecting individual privacy (e.g., by applying differential privacy to add noise to query responses, using data synthesis to generate synthetic data that closely mirrors the statistical PII in the original dataset while reducing the risk of re-identification, etc.).

At least portions of the data privacy tool 112, the statistical PII identification logic 114, the statistical PII anonymization logic 116, the statistical PII selective masking logic 118, and the statistical PII utility-preserving transformation logic 120 may be implemented at least in part in the form of software that is stored in memory and executed by a processor.

It is to be appreciated that the particular arrangement of the client devices 102, the IT infrastructure 105, the data source 108 and the analytics platform 110 illustrated in the FIG. 1 embodiment is presented by way of example only, and alternative arrangements can be used in other embodiments. As discussed above, for example, the analytics platform 110 (or portions of components thereof, such as one or more of the data privacy tool 112, the statistical PII identification logic 114, the statistical PII anonymization logic 116, the statistical PII selective masking logic 118, and the statistical PII utility-preserving transformation logic 120) may in some embodiments be implemented internal to the IT infrastructure 105.

The analytics platform 110 and other portions of the information processing system 100, as will be described in further detail below, may be part of cloud infrastructure.

The analytics platform 110 and other components of the information processing system 100 in the FIG. 1 embodiment are assumed to be implemented using at least one processing platform comprising one or more processing devices each having a processor coupled to a memory. Such processing devices can illustratively include particular arrangements of compute, storage and network resources.

The client devices 102, IT infrastructure 105, the IT assets 106, the data source 108 and the analytics platform 110 or components thereof (e.g., the data privacy tool 112, the statistical PII identification logic 114, the statistical PII anonymization logic 116, the statistical PII selective masking logic 118, and the statistical PII utility-preserving transformation logic 120) may be implemented on respective distinct processing platforms, although numerous other arrangements are possible. For example, in some embodiments at least portions of the analytics platform 110 and one or more of the client devices 102, the IT infrastructure 105, the IT assets 106 and/or the data source 108 are implemented on the same processing platform. A given client device (e.g., 102-1) can therefore be implemented at least in part within at least one processing platform that implements at least a portion of the analytics platform 110.

The term “processing platform” as used herein is intended to be broadly construed so as to encompass, by way of illustration and without limitation, multiple sets of processing devices and associated storage systems that are configured to communicate over one or more networks. For example, distributed implementations of the information processing system 100 are possible, in which certain components of the system reside in one data center in a first geographic location while other components of the system reside in one or more other data centers in one or more other geographic locations that are potentially remote from the first geographic location. Thus, it is possible in some implementations of the information processing system 100 for the client devices 102, the IT infrastructure 105, IT assets 106, the data source 108 and the analytics platform 110, or portions or components thereof, to reside in different data centers. Numerous other distributed implementations are possible. The analytics platform 110 can also be implemented in a distributed manner across multiple data centers.

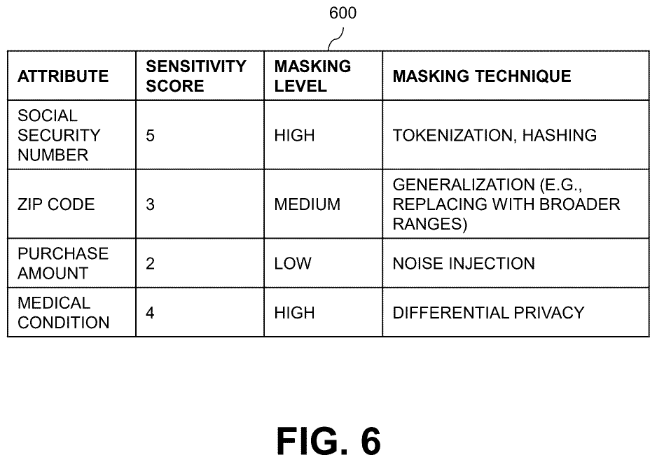

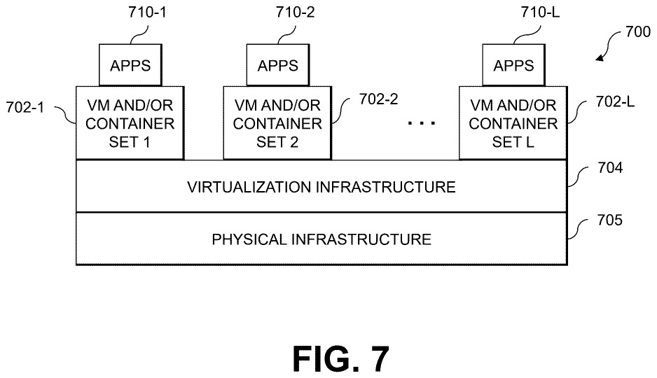

Additional examples of processing platforms utilized to implement the analytics platform 110 and other components of the information processing system 100 in illustrative embodiments will be described in more detail below in conjunction with FIGS. 6 and 7.

It is to be understood that the particular set of elements shown in FIG. 1 for data set anonymization through selective masking of statistical PII is presented by way of illustrative example only, and in other embodiments additional or alternative elements may be used. Thus, another embodiment may include additional or alternative systems, devices and other network entities, as well as different arrangements of modules and other components.

It is to be appreciated that these and other features of illustrative embodiments are presented by way of example only, and should not be construed as limiting in any way.

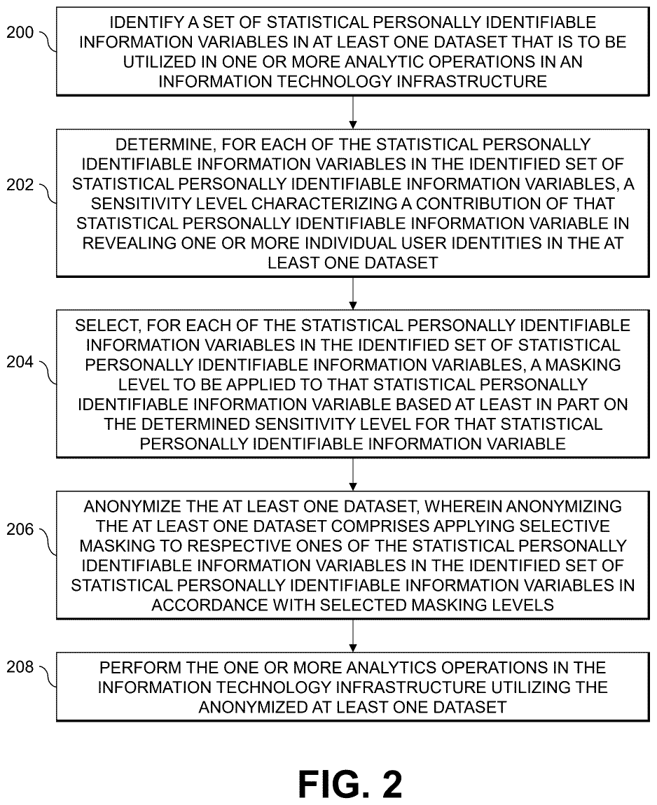

An exemplary process for data set anonymization through selective masking of statistical PII will now be described in more detail with reference to the flow diagram of FIG. 2. It is to be understood that this particular process is only an example, and that additional or alternative processes for data set anonymization through selective masking of statistical PII may be used in other embodiments.

In this embodiment, the process includes steps 200 through 208. These steps are assumed to be performed by the analytics platform 110 utilizing the data privacy tool 112, the statistical PII identification logic 114, the statistical PII anonymization logic 116, the statistical PII selective masking logic 118, and the statistical PII utility-preserving transformation logic 120. The process begins with step 200, identifying a set of statistical PII variables in at least one dataset that is to be utilized in one or more analytic operations in an IT infrastructure. The one or more analytics operations may include processing at least a portion of the at least one dataset utilizing one or more AI/ML models. Step 200 may include performing at least one of correlation, clustering and regression to determine at least one subset of a plurality of variables in the at least one dataset which, when combined, reveal one or more individual user identities in the at least one dataset. The identified set of statistical PII variables in the at least one data set comprise variables which individually are not uniquely associated with a specific individual user identity but which, when combined with one another, have at least a threshold likelihood of revealing a specific individual user identity.

In step 202, a sensitivity level is determined for each of the statistical PII variables in the identified set of statistical PII variables. The determined sensitivity level for each of the statistical PII variables characterizing a contribution of that statistical PII variable in revealing one or more individual user identities in the at least one dataset. In step 204, a masking level is selected for each of the statistical PII variables in the identified set of statistical PII variables. The masking level for each of the statistical PII variables is selected based at least in part on the determined sensitivity level for that statistical PII variable.

The at least one dataset is anonymized in step 206. Anonymizing the at least one dataset comprises applying selective masking to respective ones of the statistical PII variables in the identified set of statistical PII variables in accordance with the masking levels selected in step 204. Step 206 may include performing data generalization for the identified set of statistical PII variables. The data generalization may comprise, for a given statistical PII variable in the identified set of statistical PII variables, replacing one or more specific values of the given statistical PII variable with a value range, where a size of the value range is determined by the masking level selected for the given statistical PII variable. Step 206 may also or alternatively include performing random noise addition for the identified set of statistical PII variables. The random noise addition may comprise, for a given statistical PII variable in the identified set of statistical PII variables, obscuring one or more records in the at least one dataset including the given statistical PII variable by injecting a designated number of random records with values for the given statistical PII variable within a designated parameter value range, where the designated number of random records is determined by the masking level selected for the given statistical PII variable.

Step 206 may further or alternatively include applying a utility-preserving transformation to the at least one dataset to generate the anonymized at least one dataset. Applying the utility-preserving transformation may include adding noise to the at least one dataset and/or replacing at least a given portion of the at least one dataset with synthetic data that mirrors the given portion of the at least one dataset while reducing a risk of re-identification via the identified set of statistical PII variables.

The one or more analytics operations are performed in the IT infrastructure in step 208 utilizing the anonymized at least one dataset. In some embodiments, step 208 is responsive to successfully validating that the anonymized at least one dataset satisfies k-anonymity and l-diversity for at least a given statistical PII variable in the identified set of statistical PII variables, wherein a value of k and a value of l are selected based at least in part on the masking level selected for the given statistical PII variable. If the validation is not successful, the steps 202 through 206 may be repeated (e.g., by dynamically adjusting the determined sensitivity and masking levels for one or more of the statistical PII variables in the identified set of statistical PII variables until the anonymized at least one data set generated in step 206 is successfully validated).

The particular processing operations and other system functionality described in conjunction with the flow diagram of FIG. 2 are presented by way of illustrative example only, and should not be construed as limiting the scope of the disclosure in any way. Alternative embodiments can use other types of processing operations. For example, as indicated above, the ordering of the process steps may be varied in other embodiments, or certain steps may be performed at least in part concurrently with one another rather than serially. Also, one or more of the process steps may be repeated periodically, multiple instances of the process can be performed in parallel with one another, etc.

Functionality such as that described in conjunction with the flow diagram of FIG. 2 can be implemented at least in part in the form of one or more software programs stored in memory and executed by a processor of a processing device such as a computer or server. As will be described below, a memory or other storage device having executable program code of one or more software programs embodied therein is an example of what is more generally referred to herein as a “processor-readable storage medium.”

As discussed above statistical PII refers to data that, while not explicitly identifying an individual on its own, can be used in combination with other information to identify a likely person. This type of information is often used in statistical analysis and research while maintaining the privacy of individuals. Examples of statistical PII include demographic data such as age, gender, race, ethnicity and geographical location. While each piece of information may not directly reveal a person's identity, when combined with other data or when analyzed in aggregate, they can potentially lead to the identification of individuals.

Enterprises, organizations and other entities that handle traditional PII typically employ techniques such as data anonymization or aggregation to protect individuals' privacy while still allowing for meaningful analysis. However, it is essential to recognize that even seemingly harmless data points (e.g., statistical PII) can pose privacy risks when analyzed in aggregation with other information. Therefore, it is crucial for enterprises, organizations and other entities to handle statistical PII responsibly and in compliance with relevant data protection regulations. Illustrative embodiments provide technical solutions that are able to detect and reduce the risk of identifying individuals from anonymized statistical PII datasets, balancing privacy protection with data utility.

As enterprises, organizations and other entities adapt AI/ML approaches for data analytics to gain insights from historical data and predict future trends, the importance of safeguarding personal information, including statistical PII, becomes a top priority task. While traditional PII, like names and addresses, may be anonymized before analysis, the risk of identification through statistical PII remains a significant concern. Statistical PII, such as demographic data or behavioral patterns, might seem harmless individually but can be combined with other unmasked features to potentially identify individuals.

The exposure of statistical PII data has significant risks, not only in terms of violating data compliance regulations, but also in terms of privacy breaches and potential harm to individuals. Even though an enterprise, organization or other entity may have one or more existing anonymization processes in place, the aggregation and analysis of large datasets increases the probability of unintentionally revealing sensitive information. The technical solutions described herein, in some embodiments, address these and other technical challenges through intelligently detecting and mitigating the risk of re-identification (e.g., resulting from statistical PII), while balancing the need for data analysis and privacy protection ensuring minimum feature loss.

Consider, as an example, a customer ecosystem of an enterprise, where a Site Reliability Engineering (SRE) team of the enterprise faces technical challenges associated with protecting statistical PII data in real-time analytics. For instance, when analyzing customer usage patterns across multiple products, like server, storage and networking solutions, aggregating demographic and behavioral data is crucial for enhancing service offerings. However, there are risks which lie in accidentally revealing identifiable information through seemingly anonymized statistical PII, which could lead to privacy breaches and regulatory non-compliance. Balancing data analytics insights while protecting privacy requires technical solutions such as those described herein which are able to detect and mitigate re-identification risks, ensuring strong data governance that can help to maintain trust with customers and stakeholders.

In a SRE environment, the technical solutions described herein may be applied to effectively identify and anonymize statistical PII data in real-time analytics while ensuring minimal loss of dataset attributes. Conventional approaches are limited to anonymizing of common or traditional PII data, like names, addresses, etc. The identification of statistical PII from structured data is not or is insufficiently addressed in conventional approaches. The technical solutions described herein are able to identify statistical PII data and perform anonymization thereof, while ensuring minimal feature loss in a dataset. In some embodiments, this includes multiple steps or phases including: (1) identifying statistical PII data; (2) anonymizing the identified statistical PII data; (3) selective masking of the identified statistical PII data; and (4) utility-preserving transformation of datasets including the identified statistical PII data. The anonymization of the identified statistical PII data may utilize various anonymization techniques that are applied to identified statistical PII variables.

During the initial phase of data analysis and identification in SRE operations, a thorough examination of the dataset may be conducted to pinpoint variables which are classified as statistical PII data. This may involve employing statistical methodologies like correlation analysis, clustering, regression, etc., to unveil patterns that may accidentally or inadvertently reveal individual identifies. It is important to ensure the integrity of this process in order to prevent potential privacy breaches and to comply with regulatory requirements.

The risks associated with statistical PII data are identified and mitigated to uphold data privacy and security across a system, such as an IT infrastructure operated by an enterprise, organization or other entity. In some embodiments, anonymization techniques such as tokenization and differential privacy are implemented, along with stringent access controls (e.g., using role-based access management (RBAC)). Thus, the technical solutions described herein are able to maintain confidentiality while leveraging valuable insights from aggregated data. By integrating anomaly detection algorithms and continuous monitoring frameworks, the technical solutions described herein can enhance the ability to detect and respond to potential breaches or unauthorized access attempts promptly.

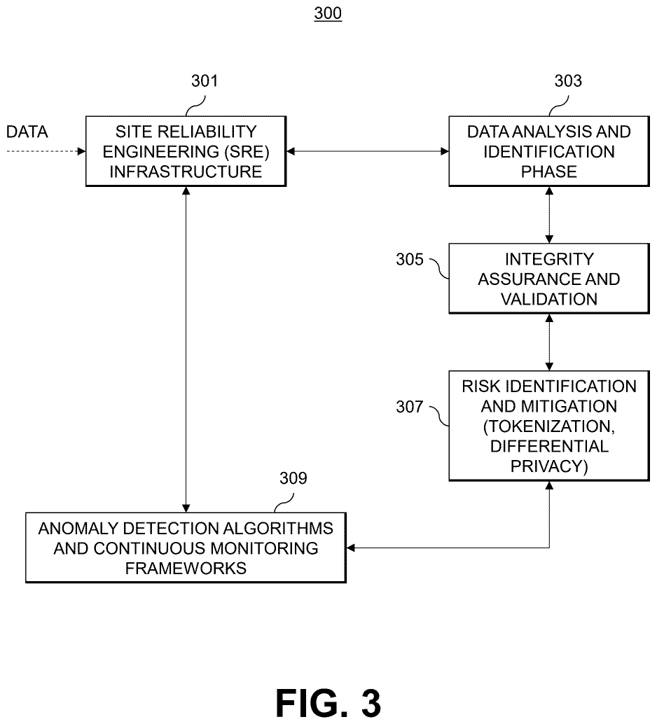

FIG. 3 shows a system 300 configured for minimizing feature loss during anonymization of statistical PII data using a selective masking approach in an SRE infrastructure or environment 301. The system 300 implements a data analysis and identification phase 303, integrity assurance and validation 305, and risk identification and mitigation 307 (e.g., through tokenization, differential privacy, etc.). The system 300 may further includes and utilizes anomaly detection algorithms and continuous monitoring frameworks 309.

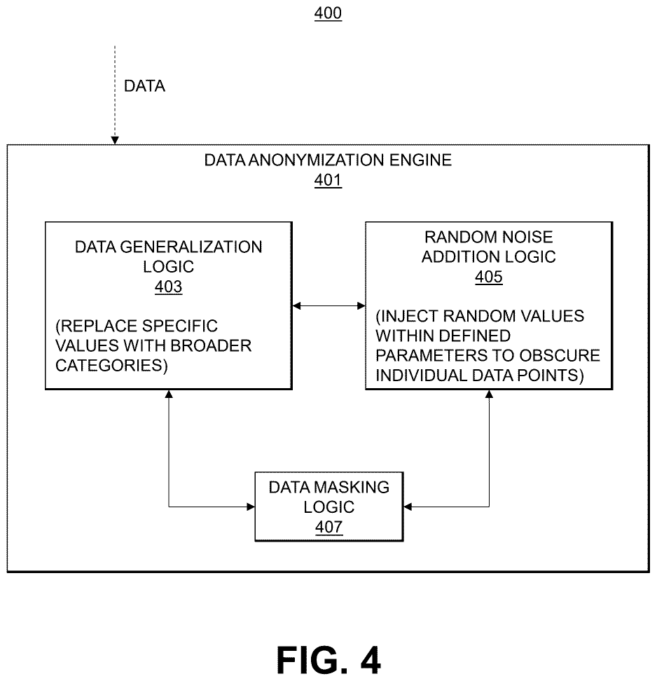

Within an SRE framework, anonymization techniques are implemented to protect identified statistical PII variables to bolster data privacy. Anonymization techniques include, by way of example, generalization (e.g., replacing specific values with broader categories, such as age ranges instead of exact ages), and the addition of random noise to obscure individual values while preserving aggregate statistics (e.g., achieved by injecting random values within defined parameters, swapping values across records, etc.). Additionally, masking will be employed to substitute sensitive information with pseudonyms or tokens, ensuring anonymity (e.g., by replacing names with randomly generated identifiers (IDs)). FIG. 4 shows a system 400 configured for anonymizing identified statistical PII variables utilizing a data anonymization engine 401. Data is received at the data anonymization engine 401, and is subject to anonymization processing implemented utilizing data generalization logic 403 (e.g., configured to perform data generalization through replacing specific values with broader categories), random noise addition logic 405 (e.g., configured to inject random values within defined parameters to obscure individual data points, to swap values across records, etc.) and data masking logic 407 (e.g., configured to substitute sensitive information with pseudonyms or tokens).

In some embodiments, selective masking is utilized. In selective masking, the sensitivity of each attribute (e.g., each statistical PII variable) is assessed, and masking techniques are applied according to the assessed sensitivity of the different attributes within the SRE framework. The selective masking can advantageously achieve a balance between anonymity and data utility by selectively masking attributes based on their sensitivity levels. Attributes deemed less sensitive may require minimal or no masking, while highly sensitive attributes will undergo more rigorous masking procedures.

In some embodiments, k-anonymity and l-diversity techniques are used to ensure the effectiveness of the masking. k-anonymity guarantees that each record in a dataset is indistinguishable from at least k−1 other records with respect to certain attributes (e.g., which may be statistical PII variables). Mathematically, for a given record Q in a dataset D, if Q is indistinguishable from at least k−1 other records, it satisfies k-anonymity:

$$\vert \{ R ∈ D \vert Q \vert QI ] = R [ QI ] \} \vert \geq k$$

where D is the dataset, Q is a record in the dataset, QI is the set of quasi-identifier attributes (e.g., statistical PII variables), R[QI] is the quasi-identifier values for a record, and |·| is the number of records.
l-diversity enhances k-anonymity by ensuring that sensitive attribute values within each equivalence class have at least one distinct value (e.g., ensuring that every equivalence class contains at least l records sharing the same sensitive value). This mitigates the risk of attribute disclosure and improves privacy protection:

$$∀ Q ∈ QI , \vert \{ t ∈ T ( Q ) \vert S ( t ) = S ( Q ) \} \vert \geq l$$

where ∀Q∈QI represents every equivalence class Q formed by the quasi-identifier QI, T(Q) is the equivalence class associated with Q (e.g., the set of records in the dataset that share the same quasi-identifier values as Q), S(t) is the sensitive attribute value of record t in the equivalence class, S(Q) is the sensitive attribute value of the reference record Q, and |·| is the size of the subset of records in T(Q) that have the same sensitive attribute value as Q, which must be at least l, ensuring diversity within the sensitive attributes.

The technical solutions described herein dynamically adjust masking levels based on evolving data sensitivity assessments, ensuring that privacy protections align with regulatory requirements and organizational policies. By implementing these techniques, data utility is preserved while enhancing anonymity, thus maintaining the integrity and confidentiality of the datasets within the SRE operational environment.

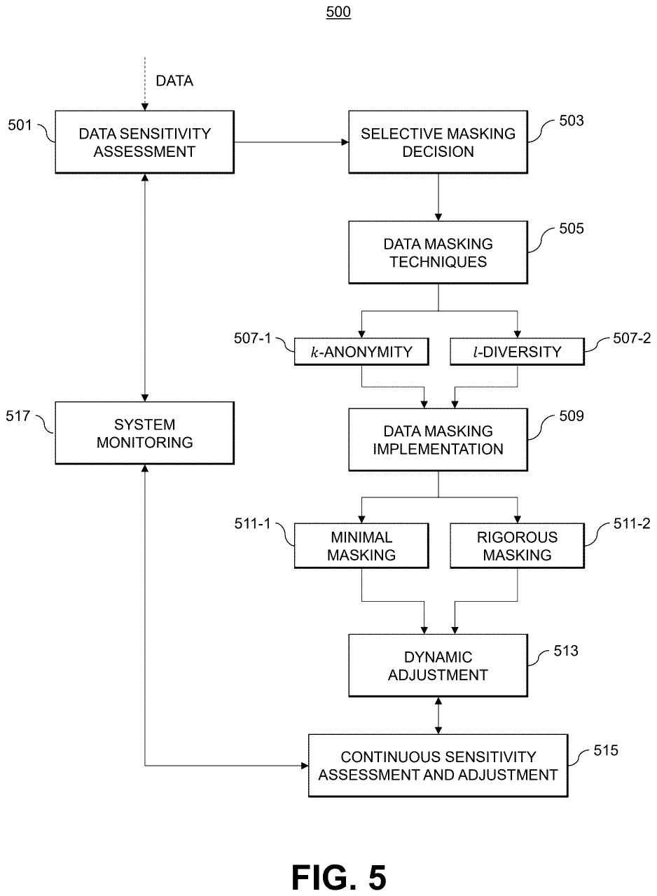

FIG. 5 shows a process flow 500 for implementing selective masking, where incoming data is subject to data sensitivity assessment in block 501, followed by a selective masking decision in block 503. Masking techniques are then selected in block 505, followed by evaluation utilizing k-anonymity in block 507-1 and l-diversity in block 507-2. Data masking is then implemented in block 509, which may include minimal masking in block 511-1 or rigorous masking in block 511-2 (e.g., depending the data sensitivity assessment in block 501). The data masking implementation may be dynamically adjusted in block 513, based on continuous sensitivity assessment and adjustment performed in block 515 based on system monitoring in block 517.

Utility-preserving transformation includes applying techniques to safeguard individual privacy while maintaining the usefulness of the data. In some embodiments, utility-preserving transformation is achieved through utilizing differential privacy, which involves adding noise to query responses. This ensures that while individual privacy is protected, valuable aggregate information is still provided. Additionally, data synthesis techniques may be used to generate synthetic data that closely mirrors the original dataset while reducing the risk of re-identification. By implementing these strategies, a balance between preserving data utility and protecting individual privacy is achieved.

Sensitivity assessment of statistical PII data includes analyzing each attribute in a dataset to determine its risk level, where the risk level is based on each attribute's potential to identify individuals, either directly or through correlation with other attributes. This process ensures that the most sensitive attributes receive the highest level of protection, while less critical attributes retain their utility. In some embodiments, performing the sensitivity assessment includes: attribute risk analysis, correlation assessment, sensitivity scoring, and dynamic risk profiling.

Attribute risk analysis includes both direct and indirect sensitivity evaluation. Direct sensitivity evaluation may be used to identify “traditional” PII variables (e.g., Social Security numbers, full names, or other variables which can directly and uniquely identify an individual on their own) which are inherently sensitive and which are classified as high sensitivity. PII variables which are classified as high sensitivity require rigorous anonymization techniques, such as tokenization, encryption, etc. Indirect sensitivity evaluation may be used to identify statistical PII variables (e.g., ZIP codes, ages, purchase patterns, etc. which are not able to uniquely identify an individual on their own but which can become sensitive when combined with other attributes), which may be classified as indirect sensitivity. Identifying indirect sensitivity may utilize correlation analysis and regression modeling.

Correlation assessment utilizes various statistical methodologies to determine how strongly attributes are linked to one another. In some embodiments, the correlation assessment is performed by applying Pearson's correlation coefficient, mutual information analysis and/or clustering to determine how strongly attributes are linked to each other. Attributes with high correlation to “direct” PII (e.g., salary strongly correlation with job title) are flagged as sensitive. Consider, for example, a healthcare dataset where a combination of age, ZIP code and medical conditions may uniquely identify individuals in small communities.

Sensitivity scoring includes assigning sensitivity scores to attributes on a scale (e.g., 1-5), where 1 indicates low sensitivity and 5 indicates high sensitivity. This scoring combines factors such as the likelihood of re-identification, presence in public datasets, and frequency of use in adversarial attacks. For example, a ZIP code may receive a sensitivity score of 3, while a Social Security Number (SSN) receives a sensitivity score of 5.

Dynamic risk profiling is used, as sensitivity assessment is not static. The sensitivity assessment is updated dynamically based on dataset changes, new insights from privacy incidents (e.g., data breaches), etc. For example, if adversaries increasingly use a specific combination of attributes for re-identification, the sensitivity scores for those attributes may be adjusted upwards. Anomaly detection algorithms may be used to monitor for changes in data usage patterns and trigger re-evaluation of sensitivity levels.

Once sensitivity levels are assigned, the attributes (e.g., PII variables) are mapped to specific masking levels. This ensures a targeted anonymization approach that minimizes data utility loss. FIG. 6 shows a table 600 illustrating sensitivity-to-masking mappings. The table 600 shows a set of attributes, their determined sensitivity scores, assigned masking levels, and masking techniques. A fine-tuned masking process may be used, where rigorous masking is applied for attributes with high sensitivity (e.g., a sensitivity score ≥4). The rigorous masking includes strict masking techniques, such as differential privacy, pseudonymization, l-diversity, etc. Minimal masking may be applied for attributes with low sensitivity (e.g., a sensitivity score≤2). The minimal masking may include techniques like light noise injection, or even leaving data untouched to maximize its utility. It should be noted that the sensitivity score range may be varied as desired, and a particular enterprise, organization or other entity can fine-tune sensitivity thresholds, masking levels, and the masking techniques used for different masking levels as desired (e.g., based on regulatory requirements, business needs, the expected adversarial risk, etc.). For example, healthcare datasets governed by Health Insurance Portability and Accountability Act (HIPAA) may require stricter masking threshold than retail datasets.

Masking for attributes of an example retail analytics dataset will now be described. Here, the attributes include ZIP code, age and purchase history. The ZIP code attribute is assigned a sensitivity score of 3, and the masking technique applied is replacing the 5-digit ZIP code with the first 3 digits, obscuring fine-grained location details but retaining regional patterns. The age attribute is assigned a sensitivity score of 2, and the masking technique applied is replacing the exact age with an age range (e.g., 25-30). The purchase history attribute is assigned a sensitivity score of 4, and the masking technique applied is using pseudonyms for product identifiers and adding random noise to purchase amounts to prevent reverse engineering of individual buying behavior.

To make the masking process adaptable to varying levels of rigor, some embodiment tune masking levels utilizing sensitivity-based parameter adjustment, hybrid techniques and/or utility-driven testing. Sensitivity-based parameter adjustment includes adjusting differential privacy noise levels based on sensitivity scores, where higher sensitivity attributes require greater noise (e.g., ε=0.1 for high sensitivity, ε=1 for low sensitivity). For high-sensitivity attributes, a combination of techniques (e.g., k-anonymity and noise injection) can be applied for stronger anonymization. Utility-driven testing includes performing utility test to assess how well anonymized datasets perform for analytics tasks, where masking parameters may be adjusted iteratively to optimize a tradeoff between privacy and utility.

The technical solutions described herein provide a cumulative approach for detecting and anonymizing statistical PII data while maintaining dataset quality and preserving features (e.g., which may be essential for AI model training). By successfully addressing the technical challenges of identifying and anonymizing statistical PII data without sacrificing dataset quality, the technical solutions described herein enable an enterprise, organization or other entity to ensure the protection of individual privacy while maximizing the value of data (e.g., for AI model training), thereby enhancing compliance with privacy regulations and instilling confidence among stakeholders. The technical solutions described herein can advantageously keep data protection aligned to meet the next-generation expectations of customers or other users, including by leveraging statistical methods for PII compliance. This approach ensures effective risk management and adherence to PII compliance regulations, which are especially important as data protection products increasingly integrate AI to enhance their intelligence in SRE and other environments.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

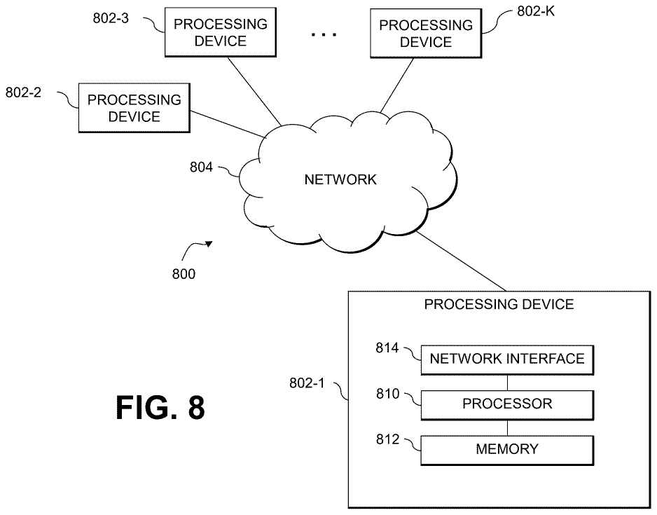

Illustrative embodiments of processing platforms utilized to implement functionality for data set anonymization through selective masking of statistical PII will now be described in greater detail with reference to FIGS. 7 and 8. Although described in the context of system 100, these platforms may also be used to implement at least portions of other information processing systems in other embodiments.

FIG. 7 shows an example processing platform comprising cloud infrastructure 700. The cloud infrastructure 700 comprises a combination of physical and virtual processing resources that may be utilized to implement at least a portion of the information processing system 100 in FIG. 1. The cloud infrastructure 700 comprises multiple virtual machines (VMs) and/or container sets 702-1, 702-2, . . . 702-L implemented using virtualization infrastructure 704. The virtualization infrastructure 704 runs on physical infrastructure 705, and illustratively comprises one or more hypervisors and/or operating system level virtualization infrastructure. The operating system level virtualization infrastructure illustratively comprises kernel control groups of a Linux operating system or other type of operating system.

The cloud infrastructure 700 further comprises sets of applications 710-1, 710-2, . . . 710-L running on respective ones of the VMs/container sets 702-1, 702-2, . . . 702-L under the control of the virtualization infrastructure 704. The VMs/container sets 702 may comprise respective VMs, respective sets of one or more containers, or respective sets of one or more containers running in VMs.

In some implementations of the FIG. 7 embodiment, the VMs/container sets 702 comprise respective VMs implemented using virtualization infrastructure 704 that comprises at least one hypervisor. A hypervisor platform may be used to implement a hypervisor within the virtualization infrastructure 704, where the hypervisor platform has an associated virtual infrastructure management system. The underlying physical machines may comprise one or more distributed processing platforms that include one or more storage systems.

In other implementations of the FIG. 7 embodiment, the VMs/container sets 702 comprise respective containers implemented using virtualization infrastructure 704 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 700 shown in FIG. 7 may represent at least a portion of one processing platform. Another example of such a processing platform is processing platform 800 shown in FIG. 8.

The processing platform 800 in this embodiment comprises a portion of system 100 and includes a plurality of processing devices, denoted 802-1, 802-2, 802-3, . . . 802-K, which communicate with one another over a network 804.

The network 804 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 802-1 in the processing platform 800 comprises a processor 810 coupled to a memory 812.

The processor 810 may comprise a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU), a neural processing unit (NPU), a data processing unit (DPU), a System-On-Chip (SOC) or other type of processing circuitry, as well as portions or combinations of such circuitry elements.

The memory 812 may comprise random access memory (RAM), read-only memory (ROM), flash memory or other types of memory, in any combination. The memory 812 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 802-1 is network interface circuitry 814, which is used to interface the processing device with the network 804 and other system components, and may comprise conventional transceivers.

The other processing devices 802 of the processing platform 800 are assumed to be configured in a manner similar to that shown for processing device 802-1 in the figure.

Again, the particular processing platform 800 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality for data set anonymization through selective masking of statistical PII as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems, IT assets, etc. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. An apparatus comprising:
at least one processing device comprising a processor coupled to a memory;
the at least one processing device being configured:
to identify a set of statistical personally identifiable information variables in at least one dataset that is to be utilized in one or more analytic operations in an information technology infrastructure;
to determine, for each of the statistical personally identifiable information variables in the identified set of statistical personally identifiable information variables, a sensitivity level characterizing a contribution of that statistical personally identifiable information variable in revealing one or more individual user identities in the at least one dataset;
to select, for each of the statistical personally identifiable information variables in the identified set of statistical personally identifiable information variables, a masking level to be applied to that statistical personally identifiable information variable based at least in part on the determined sensitivity level for that statistical personally identifiable information variable;
to anonymize the at least one dataset, wherein anonymizing the at least one dataset comprises applying selective masking to respective ones of the statistical personally identifiable information variables in the identified set of statistical personally identifiable information variables in accordance with selected masking levels; and
to perform the one or more analytics operations in the information technology infrastructure utilizing the anonymized at least one dataset.

2. The apparatus of claim 1 wherein performing the one or more analytics operations comprises processing at least a portion of the at least one dataset utilizing one or more machine learning models.

3. The apparatus of claim 1 wherein identifying the set of statistical personally identifiable information variables in the at least one dataset comprises performing at least one of correlation, clustering and regression to determine at least one subset of a plurality of variables in the at least one dataset which, when combined, reveal one or more individual user identities in the at least one dataset.

4. The apparatus of claim 1 wherein the identified set of statistical personally identifiable information variables in the at least one data set comprise variables which individually are not uniquely associated with a specific individual user identity but which, when combined with one another, have at least a threshold likelihood of revealing a specific individual user identity.

5. The apparatus of claim 1 wherein anonymizing the at least one dataset comprises performing data generalization for the identified set of statistical personally identifiable information variables.

6. The apparatus of claim 5 wherein the data generalization comprises, for a given statistical personally identifiable information variable in the identified set of statistical personally identifiable information variables, replacing one or more specific values of the given statistical personally identifiable information variable with a value range.

7. The apparatus of claim 6 wherein a size of the value range is determined by the masking level selected for the given statistical personally identifiable information variable.

8. The apparatus of claim 1 wherein anonymizing the at least one dataset comprises performing random noise addition for the identified set of statistical personally identifiable information variables.

9. The apparatus of claim 8 wherein the random noise addition comprises, for a given statistical personally identifiable information variable in the identified set of statistical personally identifiable information variables, obscuring one or more records in the at least one dataset including the given statistical personally identifiable information variable by injecting a designated number of random records with values for the given statistical personally identifiable information variable within a designated parameter value range.

10. The apparatus of claim 9 wherein the designated number of random records is determined by the masking level selected for the given statistical personally identifiable information variable.

11. The apparatus of claim 1 wherein anonymizing the at least one dataset comprises applying a utility-preserving transformation to the at least one dataset to generate the anonymized at least one dataset.

12. The apparatus of claim 11 wherein applying the utility-preserving transformation comprises adding noise to the at least one dataset.

13. The apparatus of claim 11 wherein applying the utility-preserving transformation comprises replacing at least a given portion of the at least one dataset with synthetic data that mirrors the given portion of the at least one dataset while reducing a risk of re-identification via the identified set of statistical personally identifiable information variables.

14. The apparatus of claim 1 wherein the at least one processing device is further configured, prior to performing the one or more analytics operations in the information technology infrastructure utilizing the anonymized at least one dataset, to validate that the anonymized at least one dataset satisfies k-anonymity and l-diversity for at least a given statistical personally identifiable information variable in the identified set of statistical personally identifiable information variables, wherein a value of k and a value of l are selected based at least in part on the masking level selected for the given statistical personally identifiable information variable.

15. A computer program product comprising a non-transitory processor-readable storage medium having stored therein program code of one or more software programs, wherein the program code when executed by at least one processing device causes the at least one processing device:
to identify a set of statistical personally identifiable information variables in at least one dataset that is to be utilized in one or more analytic operations in an information technology infrastructure;
to determine, for each of the statistical personally identifiable information variables in the identified set of statistical personally identifiable information variables, a sensitivity level characterizing a contribution of that statistical personally identifiable information variable in revealing one or more individual user identities in the at least one dataset;
to select, for each of the statistical personally identifiable information variables in the identified set of statistical personally identifiable information variables, a masking level to be applied to that statistical personally identifiable information variable based at least in part on the determined sensitivity level for that statistical personally identifiable information variable;
to anonymize the at least one dataset, wherein anonymizing the at least one dataset comprises applying selective masking to respective ones of the statistical personally identifiable information variables in the identified set of statistical personally identifiable information variables in accordance with selected masking levels; and
to perform the one or more analytics operations in the information technology infrastructure utilizing the anonymized at least one dataset.

16. The computer program product of claim 15 wherein the identified set of statistical personally identifiable information variables in the at least one data set comprise variables which individually are not uniquely associated with a specific individual user identity but which, when combined with one another, have at least a threshold likelihood of revealing a specific individual user identity.

17. The computer program product of claim 15 wherein the program code when executed by the at least one processing device further causes the at least one processing device, prior to performing the one or more analytics operations in the information technology infrastructure utilizing the anonymized at least one dataset, to validate that the anonymized at least one dataset satisfies k-anonymity and l-diversity for at least a given statistical personally identifiable information variable in the identified set of statistical personally identifiable information variables, wherein a value of k and a value of l are selected based at least in part on the masking level selected for the given statistical personally identifiable information variable.

18. A method comprising:
identifying a set of statistical personally identifiable information variables in at least one dataset that is to be utilized in one or more analytic operations in an information technology infrastructure;
determining, for each of the statistical personally identifiable information variables in the identified set of statistical personally identifiable information variables, a sensitivity level characterizing a contribution of that statistical personally identifiable information variable in revealing one or more individual user identities in the at least one dataset;
selecting, for each of the statistical personally identifiable information variables in the identified set of statistical personally identifiable information variables, a masking level to be applied to that statistical personally identifiable information variable based at least in part on the determined sensitivity level for that statistical personally identifiable information variable;
anonymizing the at least one dataset, wherein anonymizing the at least one dataset comprises applying selective masking to respective ones of the statistical personally identifiable information variables in the identified set of statistical personally identifiable information variables in accordance with selected masking levels; and
performing the one or more analytics operations in the information technology infrastructure utilizing the anonymized at least one dataset;
wherein the method is performed by at least one processing device comprising a processor coupled to a memory.

19. The method of claim 18 wherein the identified set of statistical personally identifiable information variables in the at least one data set comprise variables which individually are not uniquely associated with a specific individual user identity but which, when combined with one another, have at least a threshold likelihood of revealing a specific individual user identity.

20. The method of claim 18 wherein further comprising, prior to performing the one or more analytics operations in the information technology infrastructure utilizing the anonymized at least one dataset, validating that the anonymized at least one dataset satisfies k-anonymity and l-diversity for at least a given statistical personally identifiable information variable in the identified set of statistical personally identifiable information variables, wherein a value of k and a value of l are selected based at least in part on the masking level selected for the given statistical personally identifiable information variable.
